(19) United States
(12) Patent Application Publication
(10) Pub. No.: US 2022/0316726 A1
(43) Pub. Date: Oct. 6, 2022

(54) ROTARY ROOF VENT

(71) Applicants: Aleksej V. Filippov, Novocheboksarsk (RU); Dmitrij S. Ivanov Dmitrij S., Novocheboksarsk (RU)

(72) Inventors: Aleksej V. Filippov, Novocheboksarsk (RU); Evgenij I. Semenov, Cheboksary (RU); Dmitrij S. Ivanov, Novocheboksarsk (RU)

(21) Appl. No.: 17/627,740

(22) PCT Filed: Apr. 10, 2020
(86) PCT No.: PCT/RU2020/000173

§ 371 Date: Jan. 17, 2022

(30) Foreign Application Priority Data
Jul. 17, 2019 (RU) 2019122444

(51) Int. Cl. F24F 7/02

(52) U.S. Cl. CPC F24F 7/025

(57) ABSTRACT

This invention relates to smoke removal and exhaust air ventilation devices with a radial flow, namely to radial-flow (centrifugal) smoke removal and ventilation fans installed on the roofs of buildings, and providing removal of smoke, gases and air from the premises in the event of fire or gas contamination by force of the natural draft. The rotary roof vent comprises a base, a rim, blades, a shaft on which the rim with the blades rotate; wherein the base, rims with the bushings, a cover and the blades are monolithically cast from plastic, the roof vent comprises two rims mounted one in the other and connected by a locking mechanism consisting in three protuberances on the bushings, the blades are installed in the upper and lower rims, with bearings being provided for installation of the upper and lower rims. The cover is made in the form of a hemisphere. The technical result consists in the improvement of technical and operational characteristics, as well as expanding the range of technical means stack. 3 files, 2 figures.

The invention relates to smoke removal and exhaust ventilation devices with a radial flow, namely to radial (centrifugal) smoke removal and ventilation fans installed on roofs of the buildings, and providing removal of smoke, gases and air from the premises in the event of fire or gas contamination by force of the natural draft.

The rotary roof vent is used for ventilation of residential and office premises, swimming pools, hangars, grain warehouses, stock breeding complexes, structural elements of the roof (roof trees, insulation, lathing or close ceiling), removal of gas and vapors from the shafts of high-rise apartment houses and to ensure properly controlled ventilation.

There is known a roof vent (SU 5224, Publ.: 30 Apr. 1928) of a spherical shape, made of separate curved strips, which by their lower ends are connected to a ring placed on the pipe, and at the top are connected by a bolt.

From the prior art there is known a radial roof fan (RU 2415305, publ.: 27 Mar. 2011 Cert. No. 9), equipped with an impeller made of curved blades in the form of a spherical shell and mounted on the upper part of the chimney pipe, and having a vertical shaft on which the impeller rotates, vertical blades protruding beyond the spherical zone are installed on the upper base of the impeller using radial bars.

The most relevant prior art known to the inventors is a radial roof smoke and ventilating fan with an impeller (RU 2618416, publ. 3 May 2017 Cert. No. 13), which is formed having curved blades in the form of a spherical shell, with a vertical shaft on which the impeller rotates, on the upper base of which there are provided blades made of an aluminum body, and utilizing fluoroplastic bushings.

Disadvantages of above-mentioned turbo roof vents are:

1. Moisture and snow can easily penetrate inside the roof vent due to its open structure. All condensate flows down along the shaft, and go into bushings, where the bearings and moving metal parts of the roof vent are located, which results in their quick disability due to oxidation. Moisture accumulated inside the bearing and on the rotating elements freezes in winter, and the roof vents stop rotating until temperature increases.

2. Duralumin and metal oxidize as a result of contact even with when corrosive environment is not present.

3. Snow is accumulated on the top of the metal roof vents, which later turns into heavy ie, since the top surface is flat, and the snow cannot freely fall off it. This leads to the unbalance and breakdown of the installation seat, which disables the roof vent itself.

4. Metal roof vents are heavy, which imposes additional load on the bearings and results in the reduction of their life span. Secondly, the excess weight requires a stronger wind for rotation, which greatly reduces the overall useful life of the roof vent.

5. Poor aerodynamic properties caused by the simple design of the blades of metal models. The disadvantage of these devices is that in slow wind speed, the impeller rotates slowly and does not provide sufficient fan performance or cannot rotate at all due to the great inertia of the impeller, which the starting torque created by a low wind cannot overcome. In addition, due to the imbalance and the resulting friction of parts, it is difficult for the roof vents to start rotating (a stronger wind is needed) and they cannot rotate for a long time. Over time, the roof vent gets out of balance more and more, this results in decreasing the operating time.

6. Unreliable fastening of the spherical part to the base. Under the effect of high wind, due to bad rivets and thin metal the mounts are deformed at the location of connection of the head to the base. The roof vent even can pull away from the installation seat.

7. Due to the design features many parts of metal roof vents are unbalanced and asymmetrical, since they are produced manually, today there is no any roof vent fully produced at the factory. The level of workpieces accuracy is poor. Therefore, all assembled metal roof vents are also unbalanced and asymmetrical. The metal roof vent always unbalanced, so after installation it does not rotate evenly. Over time, the roof vent gets out of balance more and more, so the installation seat starts to break, as a result, this leads to the breakage of the roof vent. If you rotate the seat separately, holding the roof vent by the main body, you will see that the roof vent is completely unbalanced in relation to the axle. All holes and gaps are unbalanced, the fastenings of the roof vent parts are asymmetrical, and often loosen. The rivets are poorly fastened in the mounting holes and are made of too soft material; therefore, they break very quickly from vibration and cannot keep the structure in its original form for a long time.

8. Due to the above-mentioned drawbacks, metal roof vents require frequent maintenance consisting in lubrication of bearings and moving parts, and as they are located on roofs and are difficult to access, this often becomes very problematic.

9. The time for manufacture is too long and complicated since there are many phases at the production stage and manual labor is mostly used in the general cycle. Also, due to the manual labor and use of metal in production, the prime cost is too high, aggravated by the fact that during the production of metal roof vents about 30% of the finished parts are rejected, which also greatly affects the prime cost and the production rate.

10. Due to the structural imbalance and further reduction in balance, the metal roof vents begin to make loud noise as a result of the friction of the metal parts.

The technical problem resolved by the invention is to manufacture a turbo roof vent made of plastic with a design resolving the disadvantages of the prior art roof vents.

The previously discussed prior art problems are resolved by the rotary roof vent of the invention which contains a base, a rim, blades, an shaft, bearings, and also containing an additional rim, wherein both rims are manufactured as a single unit with the bushings and are installed in such a way that the bushings are inserted into each other by means of the bushing bosses, thus forming upper and lower rims in which the blades are installed, the cover is made in the form of a hemisphere, while the base, rims with the bushings, the cover and the blades are monolithically casted from a plastic material.

One aspect of the invention provides a rotary roof vent having a base equipped with stiffening ribs and an installation seat, enveloping the first ring by the second one, the installation seat has the recess, the rim is equipped with the stiffening ribs and reinforced installation seat enveloping the first ring by the second ring/one, the cover is made with the stiffening ribs in the form of ring from the inner side, where the latches for connection to the rim are installed, on the top and on the bottom of the blade there are provided two horizontal stiffening ribs and two latches for connection to the rim.

Another aspect of the invention provides a rotary roof vent having the base and rims with bushings, where the cover and blades are made of polypropylene.

A further aspect of the invention provides the roof vent where the blade of the rotary roof vent is 1 mm thick at the front with the thickness increasing to 1.6 mm at the back, and having a portion with substantially reduced thickness, forming a beveled corner.

The technical result, provided by the given set of features, consists in the improvement of technical and operational characteristics, as well as the expansion of the technical options.

A rotary or active roof vent (turbo roof vent) is installed at the outlet of natural ventilation pipes and is powered by wind energy. It does not consume electricity, and, therefore, this device is economically viable.

The device is designed to extract exhaust/draw air from interior rooms to the outside. The operation of a rotary roof vent is 2-4 times more efficient than the conventional one, thereby increasing the efficiency of the entire exhaust system.

The rotary roof vent protects the ventilation duct from the penetration of atmospheric precipitation and foreign objects, protects the roof from the condensate formation by lowering the air temperature in the attic, prevents overheating of the indoor premises, reduces fat deposits and dustiness of the ventilation ducts, and decorates the duct exit.

The essence of the invention is illustrated by drawings in which:

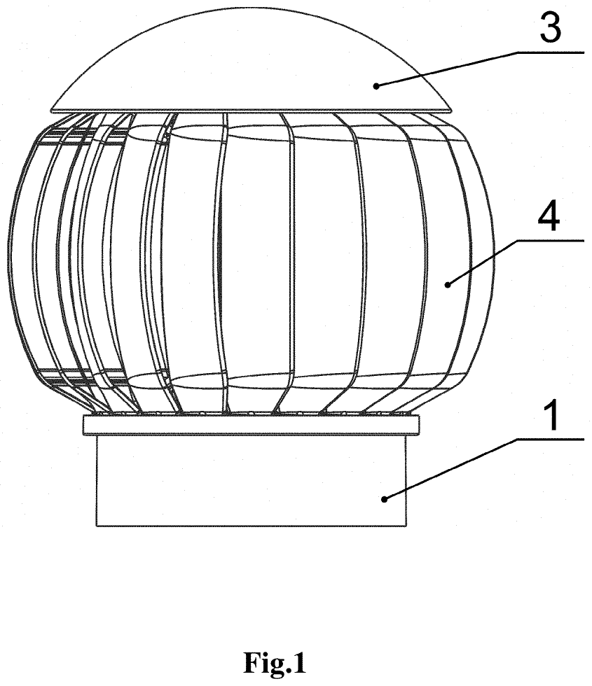

FIG. 1—is a general view of the device; and

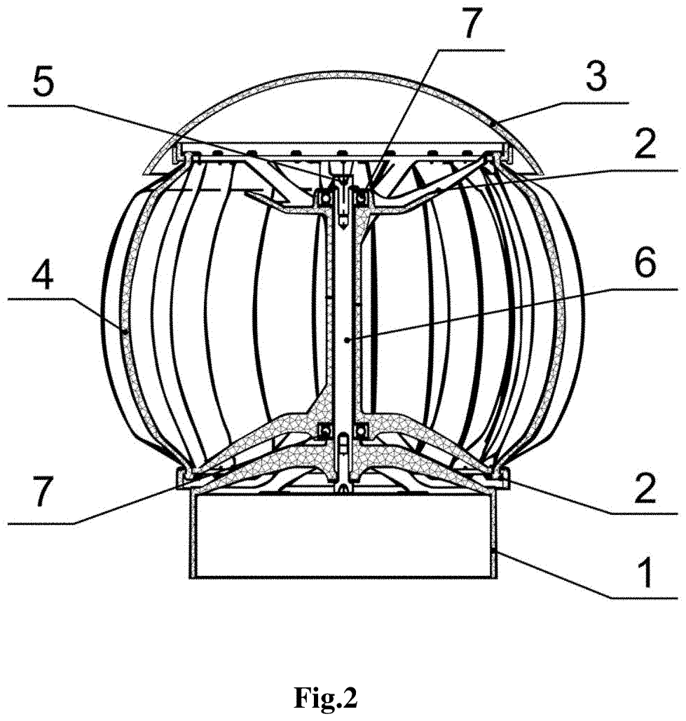

FIG. 2—is a sectional

view thereof.

Wherein,
1—base
2—rim with the bushing (upper and lower) 3—cover
4—blade (vane)
5—bolt
6—shaft
7—bearing.

The rotary roof vent (turbo roof vent) consists of a base 1 and a turbine head, which rotates in one direction regardless of the wind direction. Base 1 is rigid with six ribs additionally fastened together in the middle by a common seat. As a result, the base is rigid and cannot be deformed.

An installation frame (rims with bushings 2) is attached to the base by a rod (shaft 6), to assure the strength and rigidity of the entire structure, the blades 4 and the aerodynamic cover 3 are attached to the frame.

Bearings 7 are provided at the top and at the bottom of the installation frame to assure balancing and uniform rotating load.

The base 1 is provided with six stiffening ribs, and installation seat with a recess. The base is monolithic. Since the base is molded it is perfectly even and symmetrical. The strength of the base is enhanced by six stiffening ribs and reinforced central installation seat that envelopes the first ring with a second one. The installation seat has a recess in the shape of a bushing with a depth of 10 mm, so that the shaft fits tightly and is ideally centered in the vertical direction.

Rims 2 are monolithic. Due to the utilized molding process, the rims are even and symmetrical. Six stiffening ribs at the bottom and reinforced central seat that envelop the first ring with a second one, contribute to the strength of the rims. There are two rims in a rotary turbo roof vent installed within each other and fixed to each other by three bosses on each of the bushings having 5 mm high. These bosses in the rims are fit tightly into each other to provide additional rigidity to the structure. The cast bushing in the rim is reinforced by three stiffening ribs at the top. The bushing in two rims is one piece that protects the metal shaft from corrosive environment. The blades are tightly inserted into the upper and lower rims; twenty narrowing holes in each rim with protrusions on both sides securely fix each blade. At the base of the rim, under the bushing, there is an installation seat for a bearing which is about 10 mm deep. The bearing seat is embedded into the base of the rim at the bottom, this reliably protects the bearing from aggressive environment and assures a longer service life of the bearing.

The cover 3 is made in the form of a hemisphere, which does not allow snow and ice to accumulate on it to protect the structure against the imbalance. There are twenty aerodynamic stiffening ribs on the outside to improve the roof vent rotation at low winds. Since the cover is monolithic, it is perfectly smooth, symmetrical, and very durable. There is also a stiffening rib in the form of ring on the inner side with six latches to connect the cover to the rim. It is much larger in size than in prior art roof vents, so it fulfills increased protective function for the inner part of the roof vent, as well as the upper bearing, which reliably protects the inner part and the bearing from aggressive environments and ensures a longer life of the roof vent.

The blade (vane) 4 is designed with the consideration of the aerodynamic properties of the aircraft wing and repeats its shape. The blade is 1 mm thick at the front with the sickness increased to 1.6 mm at the back of it, and then it abruptly reduces in thickness forming a beveled corner. This shape allows the wind to create more thrust, which is of great importance when the wind has a very low intensity. The blade has two horizontal (vertical in iron roof vents) stiffening ribs at the top and at the bottom, which provide additional strength to the structure. At the top and at the bottom each blade has two cylindrical latches with protrusions on both sides, which securely fix each blade. Since the part is molded, the blade is smooth, symmetrical, and very durable.

The rotary (active) roof vent is mainly made of the following materials: base, rim with the bushing, cover, blade are made of plastic or polypropylene, bolt and shaft are made of galvanized steel, bearing is made of metal.

The aerodynamic cover improves the aerodynamic properties of the device, protects against precipitation, a n d prevents the bearing from freezing in winter due to ingress of moisture.

In view of the above-described design of the roof vent, the following characteristics are achieved: the rigidity of the entire structure, balance during rotation, noiselessness, it also provides improved operational characteristics (uniformity of rotation, rotation speed, rotation duration, minimum wind force to start rotation) and a much longer service life are achieved.

The device operates in the following manner.

The wind passing the blades (vanes), makes the head of the device to move, thereby discharging air in the system and improving thrust. Since all parts are made of lightweight materials, wind speed of 0.5 meters per second is sufficient for the operation of the turbo roof vent of the invention. Thus, the stronger the wind, the higher power is generated by the device. The turbo roof vent provides autonomous operation and excludes reverse thrust.

Thus, the disclosed rotary roof vent has the following properties (advantages):

1. The plastic roof vent is completely molded and manufactured using molds and production lines, which virtually eliminates manual labor and guarantees perfect accuracy, symmetry and balance, which ensures uniform rotation. It also contributes to quick and easy production, no rejects, any uniform color by adding dye to raw materials, and, as a result, low production costs is assured.

2. All parts are designed in such a way that the entire roof vent is rigid, tightly assembled, does not loosen over time and is durable. There are stiffening ribs on the rims, cover, base and blades, blades are equipped with the cylindrical latches with protrusions on both sides. The construction of the base with the axle inserted into it is also aimed at structural rigidity and fine balance. In the abovementioned design of the roof vent, the rigid framework, balance during rotation, noiselessness are resulted in improved operational characteristics and a much longer service life are achieved.

3. The roof vent is designed in such a way to be the leader in the market in terms of rotating properties. This is ensured by aerodynamic shape of the blades and cover, fine balance of the structure and light weight. All this allows the invention to start rotation at a lower wind and rotate at a higher speed for longer time, which ultimately provides a greater cumulative total useful life of the roof vent, and, accordingly, a much more efficient operation of the ventilation system as a whole.

4. The roof vent of the invention is designed in such a way to protect all iron parts of the device (bearings, shaft, bolts) against corrosive environments by mean of plastic. Upper bearings and bolt are covered by spherical cover, shaft is covered by the rim bushings, lower bearing and bolt are embedded in the lower rim. This ensures the durability of the metal elements and, as a result, a longer service life of the roof vent. This is because the plastic itself does not change its characteristics over time. In addition, the protection of metal parts ensures uninterrupted operation of the roof vent throughout the winter, unlike metal samples, in which moisture freezes in winter and the roof vent stops rotating until the thaw. It also eliminates the frequent maintenance of the roof vent, consisting in lubrication of the bearings, which can be difficult to do on the roof. The replacement of metal parts in the presented model is very easy and the service life of the roof vent can thus be increased several times (in metal samples, the bearings and axle cannot be replaced separately).

1. (canceled)

2. (canceled)

3. (canceled)

4. (canceled)

5. A rotary roof vent, comprising:
base, rim, blade, shaft, bearings, and an additional rim, both rims are monolithic and provided with bushings, to be installed in such a way that the bushings are inserted into each other by means of bushing bosses, thus forming upper and lower rims in which the blades are installed;
a cover is made in the form of a hemisphere, while the base, the rims with the bushings, the cover and the blades are monolithically cast from a plastic;
the base has stiffening ribs and installation seat enveloping a first ring by a second ring, the installation seat has a recess;
the rim is provided with the stiffening ribs and reinforced installation seat enveloping the first ring by the second ring; and
the cover is made with the stiffening rib in the form of a ring from an inner side where latches for connection to the rim are installed, at top and on bottom portions of the blade there are provided two horizontal stiffening ribs and two latches for connection to the rim.

6. A rotary roof vent of claim 5, wherein the base and rims with the bushings, the cover and blades are made of polypropylene. A rotary roof vent of claim 5, wherein the blade of the rotary roof vent is 1 mm thick at a front, with the thickness increased to 1.6 mm at a back portion thereof, with abruptly reduced thickness forming a beveled corner.
